(19) United States
(12) Patent Application Publication
(10) Pub. No.: US 2014/0103877 A1
(43) Pub. Date: Apr. 17, 2014

(54) BATTERY MANAGEMENT SYSTEM

(71) Applicants: SAROJ KUMAR SAHU, MOUNTAIN HOUSE, CA (US); MADHUSHREE PATNAIK, MOUNTAIN HOUSE, CA (US)

(72) Inventors: SAROJ KUMAR SAHU, MOUNTAIN HOUSE, CA (US); MADHUSHREE PATNAIK, MOUNTAIN HOUSE, CA (US)

(21) Appl. No.: 13/653,199

(22) Filed: Oct. 16, 2012

(51) Int. Cl. H02J 7/00

(52) U.S. Cl. 320/118; 320/121

(57) ABSTRACT

A battery management system that monitors and controls the charging and discharging a battery pack in the most versatile way at the block level with virtually no parasitic or dissipative loss is disclosed. The system has capability of using blocks of cells using different chemistry in the same battery pack. Such versatility makes it very useful for usage with erratic grid conditions, solar, wind and other natural energy sources for charging the battery.

### TECHNICAL FIELD

The present invention relates generally to the field of battery systems, and more particularly to a method and system for charge equalization in a flexible chemistry and flexible capacity battery system.

### BACKGROUND ART

The following terminology is adopted in this disclosure.

Cell: The Cell 10 as described in FIG. 1 is the most basic element of a battery system, with positive and negative terminals, storing and dispensing electrical energy through an electrochemical process. For example, it could be a nominal 3.7 V Lithium cylindrical cell or a nominal 2.1V Lead-Acid prismatic cell. A Cell is usually characterized by its AC Impedance (ACI), Equivalent Series Resistance (ESR), Capacity (in Amp.Hour, or in short, Ah), and Nominal Cell Voltage. The manufacturer typically provides many other parameters, such as cycle life, optimal temperature, maximum charge and discharge rate.

Block: The Block 20 as described in FIG. 2 is a collection of Cells 10 wired directly in parallel, providing the same voltage as individual Cells. All the Cells in a block must belong to the same chemistry. For instance, all Lithium Carbonate (LCO) cells, or all Lead-Acid cells. A typical Block may have as few as 1 Cell and some times as many as 1000 Cells. The current collector 21 is a conductive path, typically a metallic plate that is connected to all the positive terminals of the Cells in the Block. There are many methods of connection including soldering, welding, and spring contact. The current collector 22 is a conductive path, typically a metallic plate that is connected to all the negative terminals of the Cells in the Block. Methods of connection are similar to that of the positive side.

Although a stacked approach is shown in FIG. 2 for building a Block out of Cells, there are many other ways of making a Block as known to an expert in the field of battery manufacturing. For instance, many cells may be inserted into a set of spring-contact connectors, and the respective conductive contacts may then be electrically joined together to make a Block.

While these examples are cited for the reason of comprehension, it is to be understood that a Block is essentially a collection of Cells connected electrically in parallel.

Battery: A collection of Blocks wired in series. For instance, a 3S4P Lead-Acid battery consists of 3 Blocks wired in Series, with each Block containing 4 Cells in parallel. Such a battery would have a nominal voltage of 6.3V (Three in series multiplied by 2.1V of nominal Cell voltage). In FIG. 3 an example of a 3S4P Battery is shown. The battery 30 consists of three Blocks 35, 36 and 37. The positive terminal of the first battery 35 is typically connected to a current carrying wire 31, and is available to external devices as the positive terminal for the entire battery. The negative terminal of the last battery 37 is typically connected to a current carrying conductor 32, and is available to external devices as the negative terminal for the entire battery.

The Series connection is realized by connecting opposite parity terminals of consecutive batteries. For instance, in FIG. 3, the negative plate 22 of the top battery 35 is connected electrically to the positive terminal 21 of the middle battery 36.

The Blocks connected such may be enclosed in a mechanical cover 33 for safety or mechanical convenience.

In certain instances a Battery may be packaged in such a way that Cells of the same Block may be placed at different mechanical locations, but electrically they would be considered to belong to the same Block. In FIG. 4 we show an example of this, wherein the Battery 40 consists of two mechanical assemblies 44 and 45. It is to be noted that the two assemblies are indeed connected in parallel at the Block level. For example, the Cells in the group 46 are electrically connected in parallel with the group of cells in 47. The same applies to the other group of cells. For the purposes of this disclosure, this Battery would be considered as 3S8P, consisting of 3 Blocks, with each Block containing 8 Cells. The groups 46 and 47, for instance, form one Block of 8 Cells.

Pack: A Battery mechanically and electrically packed with a Battery Management System (BMS) for balancing, battery protection and safety, voltage and thermal sensors, and optionally active or passive thermal control devices to keep the battery at a desired temperature range.

Battery Management System (BMS): An electronic system that has components addressing, monitoring and communicating between Blocks to control the electron flow to create a balance between all the Blocks according to a pre-determined logic.

FIG. 5 shows a Battery with 3 Blocks in series. The Battery may have been charged and discharged through any number of cycles. If voltages of all the Blocks are identical or nearly identical(typically within +/−3%), then the Battery is considered to be balanced. In the case of FIG. 5, all the three Blocks have 4.2V across them—hence the Battery is balanced. In FIG. 6, the Battery has 3 Blocks, but at a given instant of time, the voltages across the Blocks are 4.4V, 4.0V and 4.2V—all different significantly from one another. (any cell >3% off from at least one other cell). Such a battery is called unbalanced.

In FIG. 7 we show a BMS that exists in the prior art and is commercially available. The Battery 30 is connected to a charger 51 and a load 52 at its positive terminal. A BMS 55 is connected to the Battery in a way that that electrical access to every terminal of every Block. For instance, the electrical line 56 is connected to the connection wire 34 between the top and the middle Block.

The electrical circuit from the charger or the load goes through the battery positive and negative terminals, and is terminated back through the BMS. The BMS therefore has the capability to close or open the electrical circuits for charging or discharging (through the load) upon certain conditions. In FIG. 7, the electrical lines 53 and 54 from the BMS control the circuit closure of the charger and the load, respectively. A temperature sensor such as thermistor is also placed into the Battery 30 and is wired to the BMS 55 with an electrical connection 58.

Such a BMS has the following major intentions
To monitor the Blocks in the Battery
To protect the battery
To estimate the battery's state of charge or instantaneous capacity
To maximize the Battery's performance by balancing the Blocks.
To communicate any important parameters of the battery to an external device or a user.

The general management functions of such a BMS are
1. Protection: Not allowing the battery, any block or any cell to operate outside of recommended operating parameters. Such function can be further subdivided as
   (a) Prevent the voltage of a Block from exceeding a limit, by stopping the charging current. In Lead-Acid batteries an excess voltage would cause excess generation or hydrogen and oxygen, while in a Lithium Ion battery it can cause the cell to fail and explode, thus causing a safety issue.
   (b) Prevent the temperature of any Cell or any Block from exceeding a limit by stopping the battery current, or requesting that it be cooled. Most Lithium Ion cells are prone to a thermal run-away if such safety mechanism is not incorporated by a BMS.
   (c) Prevent the voltage of any cell or block from dropping below a limit by stopping the discharging current. For instance, in Lithium Ion batteries, an electrode may dissolve in the electrolyte if the battery is allowed to discharge below a certain low voltage—around 2.3V. In case of Lead-Acid batteries, sulfation of electrodes may occur at very low battery voltages. In many cases such effects cause irreversible damage to the capacity of the battery.
   (d) Prevent charging current from exceeding a limit by reducing or stopping the current. For instance, in Lead acid and Lithium Ion batteries, a higher charging current than recommended causes permanent damage to electrodes, and may result in unsafe conditions. Typically, the charge current limit is a function of Block voltage, temperature, state of charge and the previous level of current.
   (e) Prevent discharging current from exceeding a certain limit by reducing or stopping the current. For instance, in Lead acid and Lithium Ion batteries, a higher discharging current than recommended causes permanent damage to electrodes, and may result in unsafe conditions. Typically, the charge current limit is a function of Block voltage, temperature, state of charge and the previous level of current.
2. Thermal Management: Controlling the thermal actuators and devices for the pack to maintain the temperature of the battery, its cells and its Blocks within a recommended range. For instance, the pack may contain thermoelectric devices that can add to or subtract heat from the pack with the application of a controlled current. The cell manufacturer's recommendation may be to run the Battery then between 15 deg C. and 35 deg C. During the operation of the battery, if the temperature falls below 15 deg C. for any block, then the TEC could be instructed to heat the pack, whereas if the temperature goes above 35 deg C., the TEC could be instructed to cool the pack. Such decisions would be taken by the BMS.
3. Balancing: Maximizing the battery's capacity by distributing or redistributing the charge among the Blocks as the battery undergoes charging and discharging.

This invention pertains to the balancing action of the BMS. During charge and discharge of the battery, one pushes a certain amount of charge into each cell. If each cell was identical in all respect, then the battery would stay balanced at all times, but they are not. Typically, there are some reasons why two different cells may not be identical in their behavior
1. Cell resistance or Equivalent Series Resistance (ESR). If the ESR of a cell is higher compared to other cells, it will respond with a larger polarization voltage than others in series to the response of the same charging current.
2. Capacity. Two different blocks may not have the same electrochemical capacity, in which case, in response to the same charging current, the voltages will be different.
3. Leakage. Depending on the age of the blocks, two different cells in two different blocks may have different internal leakage currents. Leakage current is responsible for self-discharge of a Cell, and therefore affecting the capacity of the Cell and in turn, of the Block. As a result, the effective charge and discharge capacities will be different, and will have different voltages in response to same charging current.
4. SOC. If the blocks started operating with different SOCs to start with, or if parasitic loads are taken off from intermediate blocks in a battery, the battery as a whole will stay unbalanced.

Different BMS devices do the balancing in different ways. The schemes known so far include the following
(a) Shunt Regulator Bypass: In this case a shunt power regulator is placed across each block in the BMS. During charging, when a block reaches the maximum recommended voltage, the shunt bypasses the block. Although this seems simple, the shunt regulator has to be able to carry the entire charging current in the bypass mode, which results in expensive electronics. Besides, when this happens with one or more cells, the battery charging voltage must drop keeping the current the same, thus charging the rest of the blocks. The charger needs to be able to accommodate such a voltage swing, which is not easy. Besides, if the charger is connected to a load, the load specifications may not allow this voltage swing to happen. Consequently, such a scheme is not very popular and is used only where the charging current is low (<1A or so)
(b) Dissipation: In this case, at a pre-determined range of voltage or SOC, all the blocks that have higher voltage or SOC burn some power by trickling some current to the ground or another cell. While this remains as a popular method, it is wasteful in terms of energy.
(c) Distribution: In this case, during the charging of the battery, the cells that have higher voltage or SOC transfer some of their capacity to the entire battery chain or a section of it by switching regulators. While this is less wasteful than dissipative methods, it requires high current switching passives (such as inductors and capacitors), need a lot of discrete components, and reliability and cost concerns are high.

While all the above methods are in use today, they still cannot satisfy some fundamental needs of the industry.
1. All of them still have some dissipation, and as the cells grow older, the dissipation becomes a significant portion of the total energy transacted during charging and discharging. Besides reducing the efficiency of the product, it also creates heating problems in enclosed packs.
2. If different Blocks in a battery have cells of different chemistries, the blocks would then have different charge and discharge termination voltages and therefore none of the schemes above would work.
3. If some blocks have significantly higher leakage, then balancing becomes even more wasteful and may take longer in some schemes.
4. If the blocks have different number of cells, or have different operational history, then their effective capacities may be different, and therefore the schemes would be highly dissipative or be generally ineffective.
5. These schemes generally do not offer a good way to keep the blocks balanced during discharging.
6. Besides the shortcomings above, in any of these schemes, one does not have a provision of providing one or more spare blocks that operate in unison with the rest of the blocks, but any of the blocks may be logically and electrically taken out of the string upon failure. Therefore the weakest block determines the life and capacity of the entire string.

### SUMMARY OF INVENTION

It is an object of this invention is to provide a method of balancing a battery with minimal or no dissipation.

It is also an object of this invention to provide a method of balancing a battery that may have blocks of different chemistries, different SOCs, different capacities and different operational history.

It is also an object of this invention to provide a method of balancing a battery with that keeps balancing the blocks during both, charging and discharging of the battery.

It is also an object of this invention to provide a method of balancing a battery which may have one or more dead block that need to be kept out of the string of batteries.

### BRIEF DESCRIPTION OF THE DRAWINGS

FIG. 1: Representation of a basic electrochemical cell.

FIG. 2: Representation of a Block of electrochemical cells.

FIG. 3: Representation of a Battery built out of Blocks.

FIG. 4: A Battery with segregated packs.

FIG. 5: A Battery with balanced Blocks.

FIG. 6: A Battery with unbalanced Blocks.

FIG. 7: A Battery with a BMS as known in the prior art.

FIG. 8: An SPDT switch in its default NC state.

FIG. 9: An SPDT switch in its activated NO state.

FIG. 10: A Voltage Monitoring Card for Blocks.

FIG. 11: A Temperature Monitoring Card for Blocks.

FIG. 12: Monitors, Actuators and Switch connections for a Battery according to the current invention.

FIG. 13: Switch connections for a Battery with one switch activated according to the current invention.

FIG. 14: Balance of the System for the BMS and Battery according to the current invention.

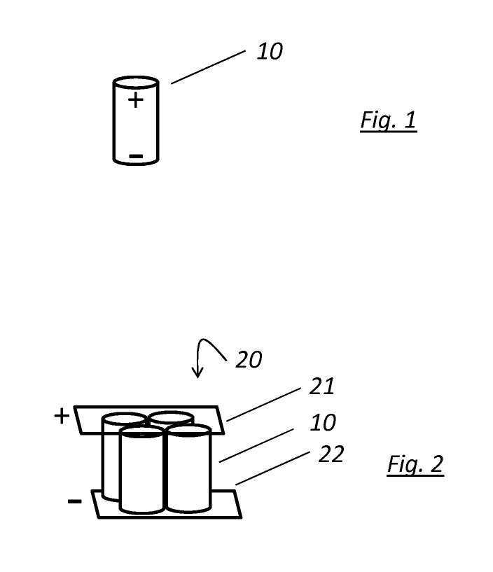

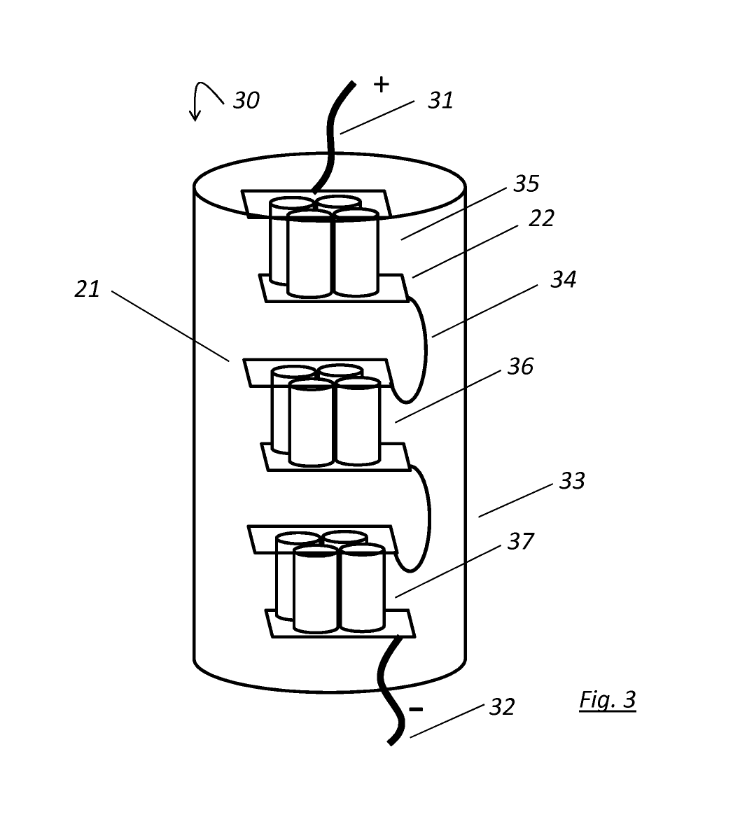

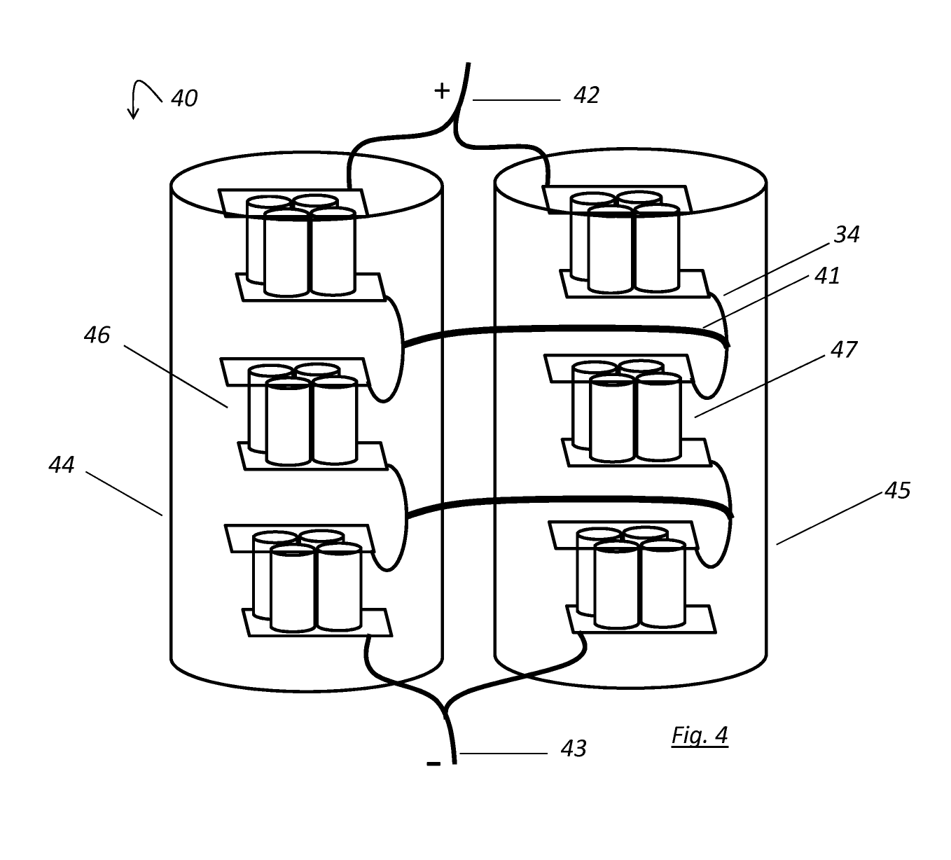

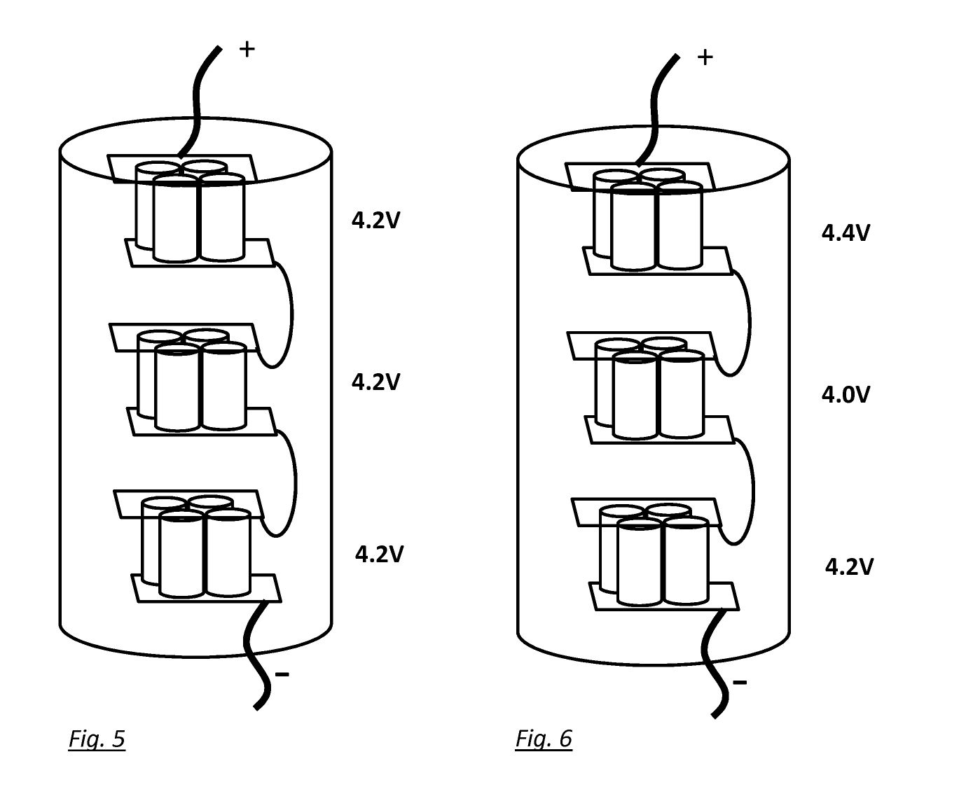

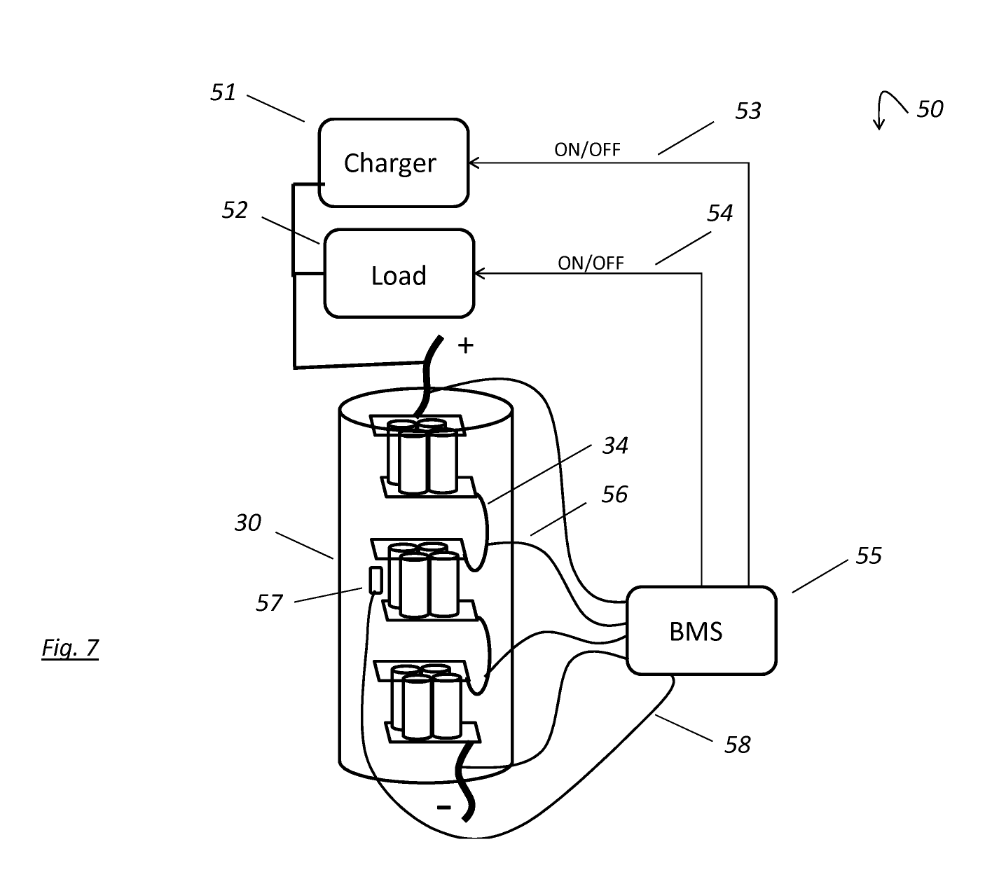

### DETAILED DESCRIPTION OF INVENTION

SPDT Switch

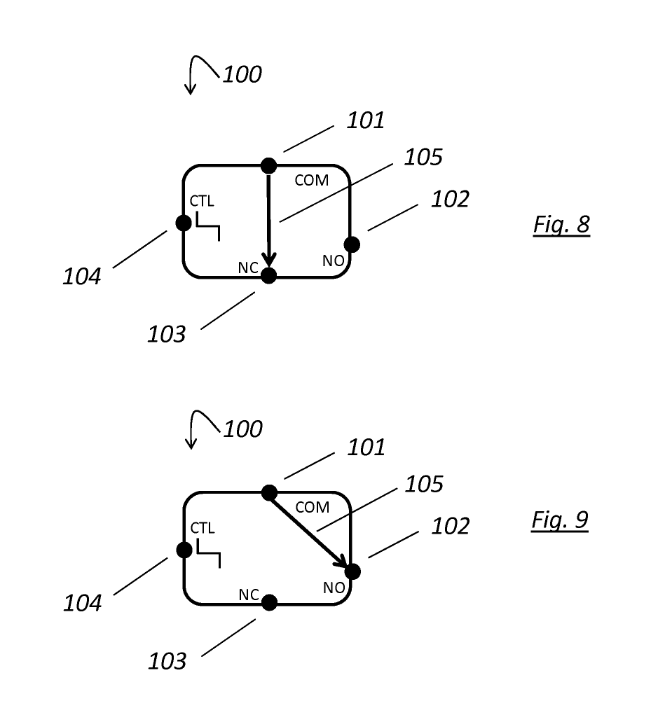

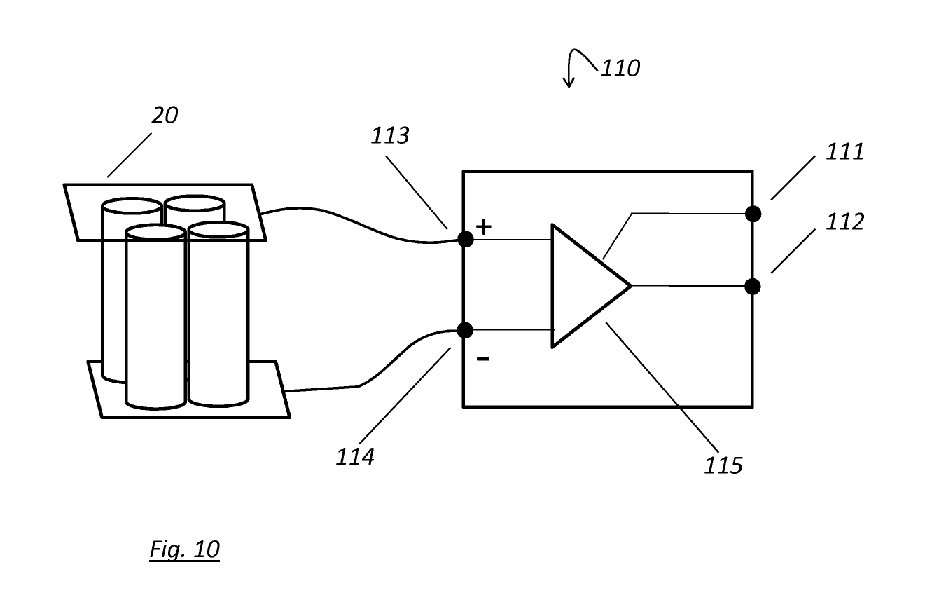

The disclosed invention uses a key component—Single Pole Double Throw (SPDT) electrical switch 100 as described in FIG. 8. In the figure, a logical and functional diagram of the device is shown. The function may be incorporated with a variety of technologies, including electromechanical relay, and solid state Mosfet. The switch 100 has three electrical terminals 101 (Common or COM), 103 (Normally Connected or NC), and 102 (Normally Open or NO). There is also an excitation terminal 104 (Control or CTL) which accepts a binary on/off signal to the switch 100. The signal may be of electrical, optical or other kind of physical stimulus. The electrical configurable path 105 responds to CTL in the following way
(a) When CTL is OFF, the connection 105 electrically connects COM to NC, with NO having co connection with COM. (as shown in FIG. 8)
(b) When CTL is ON, the connection 105 electrically connects COM to NO with NC having no connection with COM. (as shown in FIG. 9)

It may be noted that some switches may be available with the control polarity opposite to what is described above, and it is understood that a practitioner of the art in the field would still be able to use them for the same purpose by changing the driving algorithm.

Such SPDT switches are available in the form of electromechanical relay or solid state Mosfet. An example of electromechanical relay form of SPDT is CB1F series from Panasonic Electric Works.

Voltage Monitoring Circuit (VMC):

Another key component in the current invention is a voltage monitoring circuit 110 that measures the voltage of each Block 20 as shown in FIG. 10. The circuit 110 connects to the positive and negative terminals of Block 20 with inputs 113 and 114, respectively. The difference in the voltage between the two terminals 113 and 114 is amplified and conditioned by an amplifier 115, and a representative signal is provided on terminal 112. Depending on the type of circuit, the very act of reading the voltage results in a minor drainage of current from the battery, and hence to minimize that a control signal 111 may be provided to the circuit 110 to enable and disable the amplifier.

Temperature Monitoring Circuit (TMC):

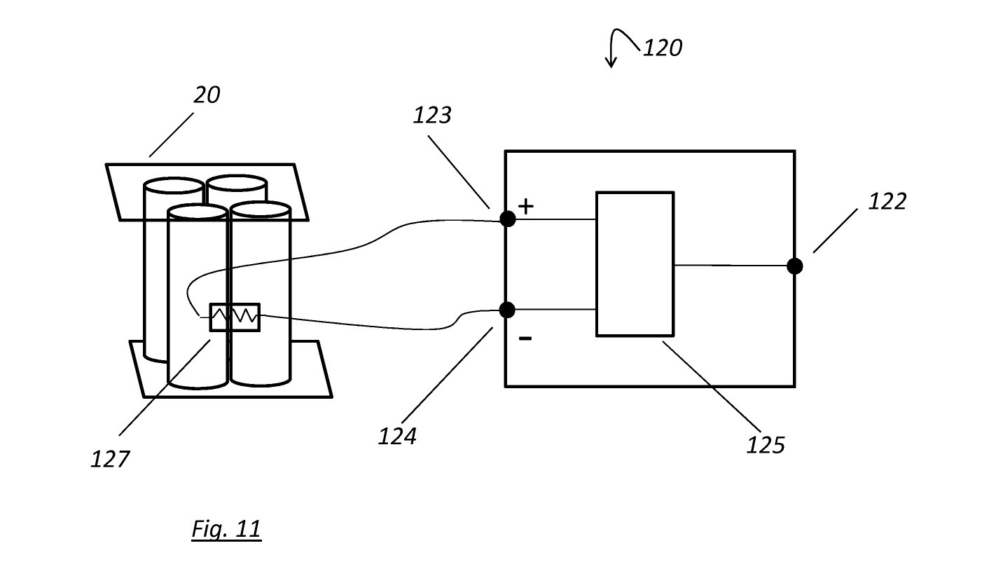

Another key component in the current invention is a temperature monitoring device and circuit as described in FIG. 11. A temperature measuring element 127 is placed on or in the Block 20, and its stimulus is quantified by the monitoring device 120 through its inputs 123 and 124. An appropriate amplifier 125 conditions the signal and provides a proportionate signal on the terminal 122.

The temperature monitoring device 127 may be comprised of many different kinds of technologies, such as thermistor, RTD, Mosfet, etc . . . . A representative devices used in this invention is part number NTSD1WD503FPB30 from Murata Electronics, which is a 50 kOhm thermistor.

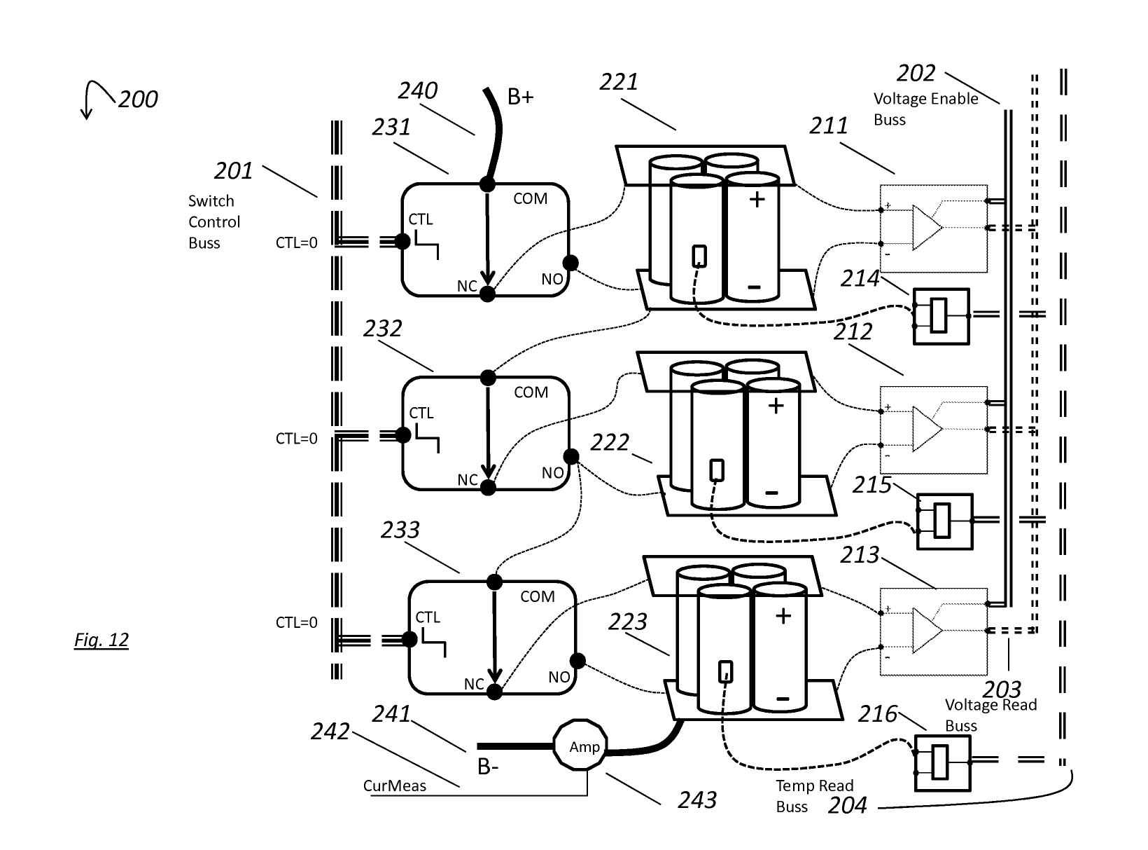

The incorporation of these elements in the current invention of BMS in the battery pack is described in FIG. 12. In system 200, three Blocks 221, 222, and 223 are shown to make up the Battery. It is arranged in such a way that they are arranged in decreasing voltage sequence in the Battery. Although only 3 Blocks are shown, the same invention can be applied in a similar method to any number of Blocks ranging in number from 2 to any large number. The Blocks 221, 222 and 223 are read by VMCs 211, 212, and 213, respectively. The outputs of the VMCs are connected to the Voltage Reading Buss (VRS) 203. The amplifier enable ports of the VMCs are connected to the Voltage Enable Buss (VEB) 202. The Blocks 221, 222 and 223 have thermistors incorporated in the packaging, and the respective thermistors are read by Temperature Monitoring Circuits (TMC) 214, 215 and 216, respectively. Outputs of the TMCs are connected to the Temperature Measurement Buss (TMB) 204. The Busses 202, 203 and 204 are connected to a central circuit to be described later.

Three SPDT switches are used in this description. The switches 231, 232, and 233 are dedicated to the Blocks 221, 222 and 223, respectively. The connections are made as follows
(a) The COM terminal of switch 231 is connected to the positive terminal 240 (B+) of the Battery. The NC terminal of switch 231 is connected to the positive terminal of the Block 221. The NO terminal of switch 231 is connected to the negative terminal of the Block 221.
(b) The COM terminal of switch 232 is connected to the negative terminal of the Block 221. The NC terminal of switch 232 is connected to the positive terminal of the Block 222. The NO terminal of switch 232 is connected to the negative terminal of the Block 222.
(c) The COM terminal of switch 233 is connected to the negative terminal of the Block 222. The NC terminal of switch 233 is connected to the positive terminal of the Block 223. The NO terminal of switch 233 is connected to the negative terminal of the Block 223.
(d) The negative terminal of the Block 223 is connected to the negative terminal of the Battery 241 (B−).
(e) A current sensor 243 is incorporated on the B− line to measure the stack current which is reported through a signal 242 to a central processing unit as described later. It is to be noted that the current sensor could be installed on the positive line B+ as well.

The control ports of the switches 231, 232 and 233 are connected to a Switch Control Buss (SCB) 201, which is connected to a central processing unit to be described later.

When the CTL ports of the switches receive an OFF signal, the electrical connections of the switches to the Blocks are shown as in FIG. 12. It can be observed that by virtue of the state of the switches, the Blocks 221, 222, and 223 are connected in series. As a result, whether the pack is being charged or discharged, the entire set of Blocks is engaged in series.

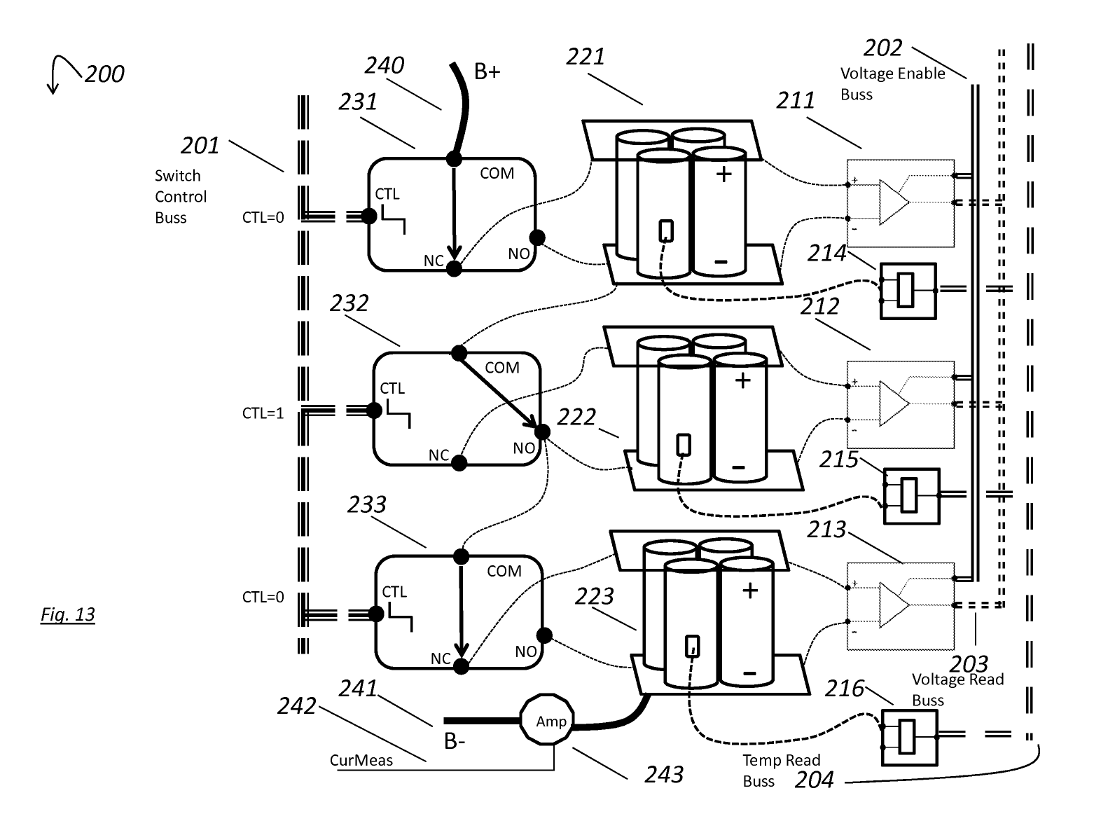

As will be described later, the algorithm will require a certain Block to be taken out of the Battery electrically. As an example, if the middle Block 222 is required to be taken out of the Battery, then the CTL signal of the corresponding switch 232 is turned ON. In response to the signal, the connection in switch 232 is thrown from COM-NC to COM-NO. As a result, the negative terminal of 221 is electrically connected to the positive terminal of Block 223 through COM-NO of 232 and COM-NC of 233, completely by-passing the Block 222. The connection is shown in FIG. 13. Therefore, no current flows through the Block 222, and to the outside, the sum of voltages of Blocks 221 and 223 are available. In this way, any other Block can be taken out of the Battery. For instance, in order to take out the Blocks 221 or 223 from the Battery, one would turn ON the CTL ports of switches 231 or 233, respectively.

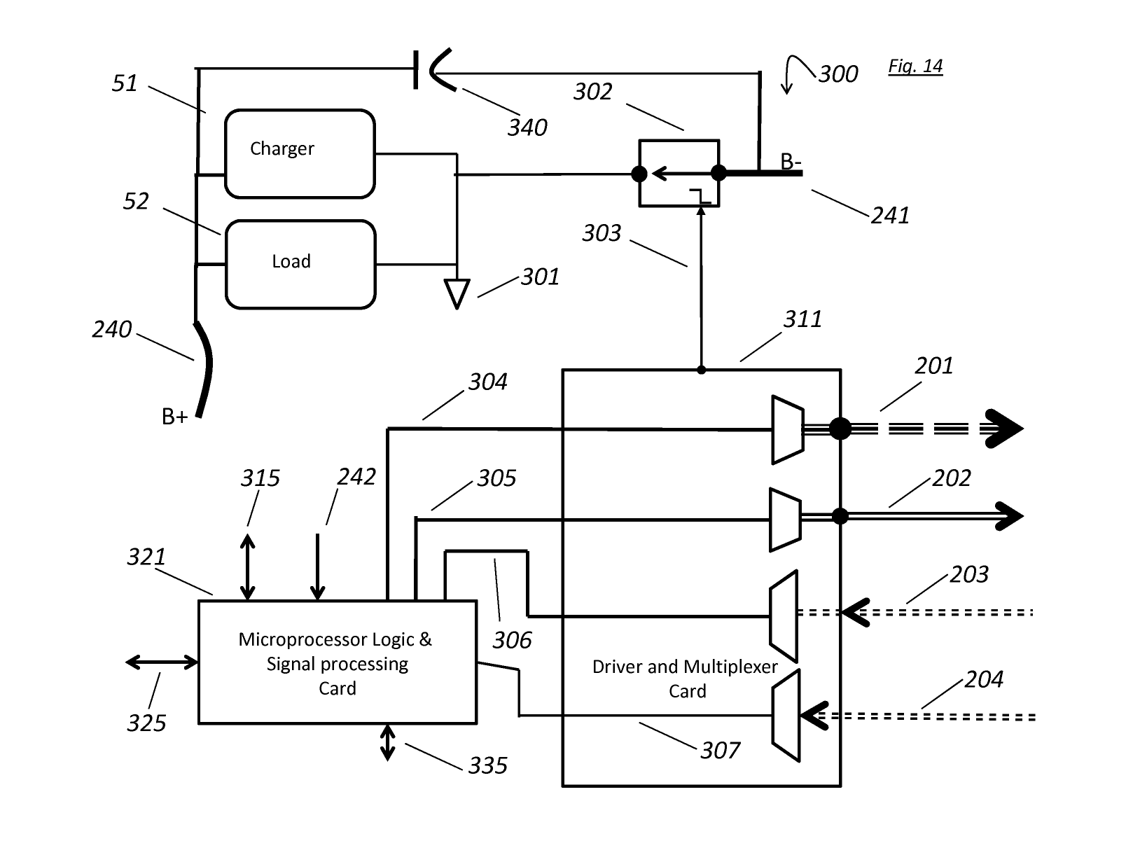

The connection of the Battery in the pack is shown in FIG. 14 as Balance of the System (BOS) 300. The battery Charger 51 provides the voltage and current according to the need of the system. In this implementation it is a Constant-Current-Maximum-Voltage charger wherein the charger pushes a prescribed about of current into the pack as long as the pack voltage is less than a prescribed Maximum Voltage. When the Maximum Voltage is reached, the charging current is tapered down so as to keep the Maximum Voltage a constant. The negative terminal of the Charger 51 is connected to the system ground 301. The positive terminal of the Charger 51 is connected to the battery positive 240 (B+), which further flows in FIGS. 12 and 13. The pack discharges into a Load 52 which may have varying current requirements and may even have its own power conditioning circuits to change the voltage or current levels for a final application. The negative terminal of the Load 52 is connected to the system ground 301. The positive terminal of the Load 52 is connected to the battery positive 240 (B+), which further flows in FIGS. 12 and 13.

An electrical accumulator such as an electrolytic capacitor 340 is connected between B+ and B− terminals to provide power to load for the time period during which an SPDT switch is changing state and therefore interrupts the pack current. This is especially important during discharging. The size of the capacitor 340 depends on the switching time of the SPDT switches and the maximum load planned. For solid state switches the switching time is typically less than 100 micro-seconds, whereas for electromechanical relays the switching time is typically between 3 and 25 milli-seconds.

A current interrupter 302 in the form of a solid state switch is placed on the return line 241 (B−) before it goes to the ground. The current interrupter acts in response to a control signal 303 delivered from the system electronics to be described below. The system algorithm may activate this interrupter to open the battery current path from the charger 51 or load 52 during many circumstances including but not limited to over-charging, over-discharging, short-circuit, and over-temperature. While the current interruption device 302 is in the open state, and the charger loses its power, necessitating the pack to provide current to the load, the device 302 detects the power failure and closes itself during a time period not material to the operation of the load.

The whole pack system is controlled by a microprocessor unit (MPU) 321, which includes a microprocessor and many auxiliary units, such as memory, Analog to Digital Converter (ADC), Amplifiers and other signal conditioners and recorders. It also communicates with the sensors and actuators in the battery pack via a Driver and Multiplexer Card (DMC) 311. The MPU 321 communicates with the DMC 311 through the channel 304 to control the Switch Control Buss (SCB) 201. The MPU 321 communicates with the DMC 311 through the channel 305 to control the Voltage Enable Buss (VEB) 202. The MPU 321 communicates with the DMC 311 through the channel 306 to read the Voltage Reading Buss (VRB) 203. The MPU 321 communicates with the DMC 311 through the channel 307 to read the Temperature Reading Buss (VRB) 204.

The MPU 321 reads the current measurement 242. It also stores and retrieves system and temporal information, such as calibration constants, real time clock, algorithm parameters with a memory device through the port 335. The MPU 321 communicates with the outside world through the communication post 325. In this example, it is an RS-232 port that transmits and receives data in both wire-line and wireless means.

The MPU 321 can actuate and control a thermal control device through the port 315.

The algorithm implemented for the operation of the battery is described below.

In this implementation, the battery pack was required to be charged at 0.5C rate. Therefore the time taken to fully charge the system from zero state of charge is about 2 hours. The load for the application was about 0.2C. Therefore a fully charged system would take about 5 hours to fully discharge.

Algorithm During Charging:

During Charging, the voltages of the Blocks are measured by activating elements in the VEB 202 and reading the Block voltages through the VRB 203. The Block with the maximum voltage is determined to be the Xth Block. As the next step, the switch corresponding to the Xth Block is turned ON through the SCB 201, with all other switches being OFF, and the Xth Block is isolated from the Battery, whereas all other Blocks are electrically in series. That gives other Blocks a chance to catch up in voltage with Xth Block which is already sitting at a higher voltage. Such condition is maintained for 1 minute, after which the Xth Block is put back into the Battery by turning the corresponding switch OFF. Such condition is maintained for 5 seconds so that all the Block voltages are stabilized. Now the process is started again with measuring all the voltages and finding out the highest voltage block and isolating it. This cyclic operation can be done about 100 times during 2 hours of charging, and that gives enough iterations to balance all the Blocks within reasonable means. Even if all the Blocks may not be balanced during one cycle, doing such algorithm over several cycles will balance them.

During the charging cycles, if any of the Blocks reach a prescribed maximum Block voltage, then the charging of that Block is deemed complete and it is taken out of the Battery by activating the corresponding SPDT switch for the rest of the charging cycle. This prevents over-charging and damage to the battery. When one or more of such Blocks have been switched out of the Battery, and the specifications for the charging voltage and current are no longer met, the entire Battery is deemed completely charged and the current interruption device 302 is opened to prevent further charging. As described earlier, the device 302 reacts quickly to close itself upon a loss of power of the charger in order for the pack to provide power to the load.

During charging cycles, if any of the temperature sensors read a temperature higher or lower than the prescribed limits, then appropriate action is taken through the port 315 in order to cool or heat the pack accordingly. Under certain circumstances the over-heated Block may be taken off the Battery electrically by switching ON the corresponding SPDT switch.

During charging cycles, for any reason if a particular Block is deemed defective, it can be taken out of the Battery for the entire cycle by switching ON the corresponding SPDT switch. Depending on the voltage and current requirements, redundancy in terms of number of Blocks in the Battery can be built in so that provision may be made for errant Blocks to be taken out of the Battery without violating the specifications of voltage and current for the entire pack.

Algorithm During Discharging:

During Discharging, the voltages of the Blocks are measured by activating elements in the VEB 202 and reading the Block voltages through the VRB 203. The Block with the minimum voltage is determined to be the Xth Block. As the next step, the switch corresponding to the Xth Block is turned ON through the SCB 201, with all other switches being OFF, and the Xth Block is isolated from the Battery, whereas all other Blocks are electrically in series. That gives other Blocks a chance to catch up in voltage with Xth Block which is already sitting at a lower voltage. Such condition is maintained for 1 minute, after which the Xth Block is put back into the Battery by turning the corresponding switch OFF. Such condition is maintained for 5 seconds so that all the Block voltages are stabilized. Now the process is started again with measuring all the voltages and finding out the lowest voltage block and isolating it. This cyclic operation can be done about 300 times during 5 hours of discharging, and that gives enough iterations to balance all the Blocks within reasonable means. Even if all the Blocks may not be balanced during one cycle, doing such algorithm over several cycles will balance them.

During the discharging cycles, if any of the Blocks reaches a prescribed minimum Block voltage, then the discharging is deemed complete for that Block, and is taken out of the Battery by activating the corresponding SPDT switch. This prevents over-discharging and damage to the battery. When one or more of such Blocks have been switched out of the Battery, and the specifications for the discharging voltage and current are no longer met, the entire pack is deemed completely discharged and the current interruption device 302 is opened to prevent further charging and damage to the Battery.

During discharging cycles, if any of the temperature sensors read a temperature higher or lower than the prescribed limits, then appropriate action is taken through the port 315 in order to cool or heat the pack accordingly. Under certain circumstances the over-heated Block may be taken off the Battery electrically by switching ON the corresponding SPDT switch.

During discharging cycles, for any reason if a particular Block is deemed defective, it can be taken out of the Battery for the entire cycle by switching ON the corresponding SPDT switch. Depending on the voltage and current requirements, redundancy in terms of number of Blocks in the battery can be built in so that provision may be made for errant Blocks to be taken out of the Battery without violating the specifications of voltage and current for the entire Battery.

During Either Charging or Discharging:

The health of the system and its Blocks can be periodically monitored and the data may be conveyed to an external computing device for further analysis. An offline or online analysis may be done with or without human participation and if necessary certain Blocks may be taken out electrically for the entirety of the cycle.

Other Implementations:

The disclosed example shows a typical application of the invention, and a practitioner of the field would derive many similar applications based on the invention, which are covered under the rights of this invention.

Although in the given example, the time period during which a particular Block is switched out depends on the voltage readings of all the Blocks, leading to a Voltage-based algorithm, in another implementation, the decision may be based on calculation on State of Charge (SOC) or based on Coulomb Counting.

In another implementation, one or more Blocks would have a different nominal capacity than the rest of the Blocks. The Blocks can still be charged and discharged simultaneously, thereby providing maximum capacity, by switching in the lower capacity Blocks with a systematically lower duty factor, as determined by an appropriate algorithm.

In yet another implementation, one of more Blocks would have cells of a different chemistry than other Blocks, leading to a different Block voltage and a different voltage-current characteristics. The Blocks can still be charged and discharged simultaneously, thereby providing maximum capacity, by switching in the lower capacity Blocks with a systematically lower duty factor, as determined by an appropriate algorithm.

1. A battery management system (BMS) comprising of at least two blocks of electrochemical cells, with the voltage of each block being monitored with a high impedance circuit in response to a command from a central processor, with each block being connected through a single pole dual throw (SPDT) switch with the rest of the blocks in a way that
(a) The pole COM of the switch is connected to the negative terminal of the cell higher in voltage in the series sequence,
(b) The default throw position NC is connected to the positive terminal of the block,
(c) The actuated throw position NO is connected to the negative terminal of the block,
(d) If the block is the highest in voltage in the battery, then the COM pole is connected to the positive terminal of the entire battery,
(e) If the block is the lowest in voltage in the battery, then the negative terminal of the block is connected to both, the NO throw position of the block and the negative terminal of the battery,
whereas the pole COM is electrically connected to NC by default, offering the full Block voltage to the battery and is electrically connected to NO upon receipt of an activation signal, taking the Block out of the Battery electrically, and replacing it with an electrical short.

2. The BMS of claim 1, wherein periodically the Block voltages are monitored, and in response to that, one or more Blocks are taken out of the Battery electrically by activating the switch, therefore keeping their capacity substantially unchanged during that period, while the other Blocks staying at their default state keep getting charged or discharged.

3. The BMS of claim 2, wherein periodically, in response to known capacity and state of charge, one or more Blocks are taken out of the Battery electrically by activating the switch, therefore keeping their capacity substantially unchanged during that period, while the other Blocks staying at their default state keep getting charged or discharged.

4. The BMS of claim 2, wherein the period of switching during which the Block voltages are measured and the switch activation is in effect, is less than 10 times the total average charge time of the battery required by the application.

5. The BMS of claim 2, wherein the switch is an electro-mechanical relay with two throw positions and one pole.

6. The BMS of claim 2, wherein the switch is a solid state electrical switch with no moving parts with two throw positions and one pole.

7. The BMS of claim 2, wherein the Battery has at least one Block that is of different chemistry than the rest of the Blocks.

8. The BMS of claim 2, wherein any of the Blocks deemed unusable is permanently taken out of the Battery electrically by activating the corresponding switch during both, charge and discharge.

9. The BMS of claim 2, wherein during charging, at a predetermined Block maximum voltage or Battery maximum voltage, the current path from the charger is broken with an electrical interrupter in order to prevent the Block or the Battery from over-charging.

10. The BMS of claim 2, wherein during discharging, at a predetermined Block minimum voltage or Battery minimum voltage, the current path from the load is broken with an electrical interrupter in order to prevent the Block or the Battery from over-discharging.

11. The BMS of claim 1, wherein a central signal processing and decision unit reads the Block voltages and actuates the SPDT switches according to a predetermined algorithm.

12. The BMS of claim 11, wherein one or more Blocks are provided with temperature sensors read by the central signal processing and decision unit which based on the thermal conditions and predetermined algorithm makes decisions of taking a Block out of the Battery electrically by activating an SPDT switch, activating a thermal cooler or heater to condition the battery temperature, or shutting down the entire battery to prevent an unsafe thermal condition.
